(19) United States
(12) Patent Application Publication
(10) Pub. No.: US 2023/0098269 A1
(43) Pub. Date: Mar. 30, 2023

(54) INPUT SHAFT SEALS FOR A TRANSMISSION DESIGN SERIES

(71) Applicant: ZF Friedrichshafen AG, Friedrichshafen (DE)

(72) Inventors: Simon Hetmaniok, Witten (DE); Christian Lohmann, Witten (DE)

(73) Assignee: ZF Friedrichshafen AG, Friedrichshafen (DE)

(21) Appl. No.: 17/905,347

(22) PCT Filed: Mar. 1, 2021
(86) PCT No.: PCT/EP2021/054974

§ 371 Date: Aug. 31, 2022

(30) Foreign Application Priority Data
Mar. 31, 2020 (DE) 10 2020 204 204.7

(51) Int. Cl. F16H 57/033; F16H 57/029; F16H 57/031

(52) U.S. Cl. CPC F16H 57/033; F16H 57/029; F16H 57/031

(57) ABSTRACT

A transmission type series with at least two transmissions that each have an input shaft (103, 203), a housing (105, 205), and a cover (107, 207). The housings (105, 205) each form a flange (109, 209) in which the respective cover (107, 207) is secured oil-tight. The input shafts (103, 203) penetrate through the respective cover (107, 207) and the covers (107, 207) each have at least one seal (111, 211a, 211b, 211c) to form a seal against the respective input shaft (103, 105). The flanges (109, 209) have an identical design and the seals (111, 211a, 211h, 211c) differ.

### RELATED APPLICATIONS

This application claims the benefit under 35 U.S.C. § 371 as a U.S. National Phase Application of application no. PCT/EP2021/054974 filed on 1 Mar. 2021, which claims benefit of German Patent Application no. 10 2020 204 204.7 filed 31 Mar. 2020, the contents of which are hereby incorporated herein by reference in their entireties.

### FIELD OF THE INVENTION

The invention concerns a transmission type series,

### BACKGROUND

When customers place differing requirements on tightness and durability in relation to the ambient conditions prevailing at the installation location, different seal solutions must be provided for the input shafts. In each case, this requires a redesign of the transmission input.

### SUMMARY

The invention is based on the task to simplify the seal design for a transmission input. This task is solved with a transmission type series as disclosed herein. Example embodiments are described in the claims and the detailed description and are illustrated in the figures.

A transmission type series is an arrangement of at least two transmission that match with regard to the adaptation of at least one technical feature.

The transmission type series according to the invention comprises a first transmission and a second transmission. The first transmission and the second transmission each have an input shaft, a housing, and a cover.

The housing of the first transmission and the housing of the second transmission each form a flange. This is a housing opening with a means to secure the respective cover such that the cover closes the opening at least partially, preferably fully.

The cover of the first transmission is secured in the flange of the first transmission. Likewise, the cover of the second transmission is secured in the flange of the second transmission. In each case the cover is secured oil-tight such that oil cannot leak between the flange and the respective cover. For this purpose, a seal, for example, a solid seal, is arranged between the flange and the respective cover.

The input shaft of the first transmission penetrates the cover of the first transmission. Likewise, the input shaft of the second transmission penetrates the cover of the first transmission. Similarly, the input shaft of the second transmission penetrates the cover of the second transmission. This implies that the covers in each case have an opening through which the respective input shaft penetrates. Two parts of each input shaft are as a result located on different sides of the respective cover. One part of the respective input shaft is located in the transmission interior, a further part is located outside of the transmission.

The cover of the first transmission has at least one seal to seal this cover against the input shaft of the first transmission. Likewise, the cover of the second transmission has at least one seal to seal this cover against the input shaft of the second transmission. The seal is in each case preferably oil-tight, such that oil cannot leak from the respective transmission between the covers and the respective input shaft.

According to the invention, the flange of the first transmission and the flange of the second transmission have an identical design. Two technical means or arrangements of means have an identical design when their physical parameters in particular their materials and geometry properties—match within the scope of occurring manufacturing tolerances.

In contrast to the flanges, the seals vary. At least one seal of the first transmission is therefore different from the at least one seal of the second transmission. This means that the totality of all seals used to seal the cover of the first transmission against the input shaft of the first transmission differs from the totality of all seals used to seal the cover of the second transmission against the input shaft of the second transmission.

Two technical means or arrangements of means differ or differ from each other when their designs are not identical. This means that there is a difference between the means or arrangements in at least one physical parameter that is not manufacturinginduced and is therefore outside the scope of occurring manufacturing tolerances.

Flanges of identical design result in scale effects accompanied by cost savings. The different seals in this case allow the respective transmission to be adapted to the respective requirements, as described above.

In a preferred further embodiment, the input shaft of the first transmission and the input shaft of the second transmission each have a ring. The ring of the input shaft of the first transmission and the ring of the input shaft of the second transmission differ. The rings are preferably secured to the respective input shaft with a friction lock and/or a positive lock. The rings are secured such that oil cannot leak from the respective transmission between the rings and the rest of the respective shaft.

At least one part of at least one seal of the first transmission seals the cover of the first transmission against the ring of the input shaft of the first transmission. Likewise, at least one part of at least one seal of the second transmission seals the cover of the second transmission against the ring of the input shaft of the second transmission.

The seal according to the further embodiment against the rings is advantageous because the input shafts can easily be adapted to the different seals of the respective transmission using the rings. In a preferred further embodiment, in particular, input shafts can be used that have an at least partially identical design.

According to the further embodiment, at least one part of the input shaft of the first transmission and at least one part of the input shaft of the second transmission have an identical design. The respective ring is arranged on the parts of the input shafts with an identical design. The ring of the input shaft of the first transmission is therefore arranged on the at least one part of the input shaft of the first transmission. Likewise, the ring of the input shaft of the second transmission is arranged on the at least one part of the input shaft of the second transmission. With exception of the respective ring, the input shafts preferably have an identical design. The input shafts then consist of a base body and the respective ring, wherein the base bodies have an identical design.

At least one seal of the second transmission is preferably embodied as a Taconite seal, A Taconite seal is a seal arrangement that comprises a radio shaft seal ring, a V-ring seal, and a labyrinth seal. These three individual seals are arranged in series, along a gap to be sealed. Oil exiting through the gap must pass the three seals in series.

In a preferred further embodiment, the V-ring seal and the labyrinth seal form a cavity. The cavity is without limitation delimited by the V-ring seal and the labyrinth seal. It is at least partially filled with grease. This improves the sealing effect.

At least one seal of the first transmission is preferably formed as a radial shaft seal ring. The radial shaft seal ring forms at least one seal according to the further embodiment. This means that the cover of the first transmission is exclusively sealed by the radial shaft seal ring against the shaft or the ring of the shaft.

In yet another preferred further embodiment, not only the flanges but also the entire housings of the first transmission and the second transmission have an identical design.

### BRIEF DESCRIPTION OF THE DRAWINGS

A preferred exemplary embodiment of the invention is shown in the figures. In detail, these show in:

FIG. 1 a section of a first transmission of a type series; and in

FIG. 2 a section of a second transmission of the type series.

### DETAILED DESCRIPTION OF EXAMPLE EMBODIMENTS

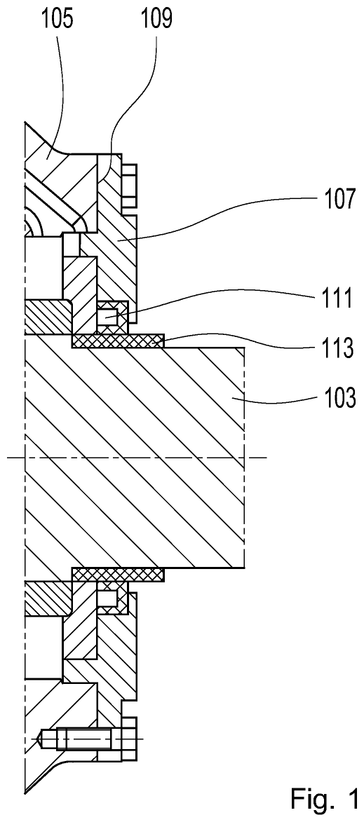

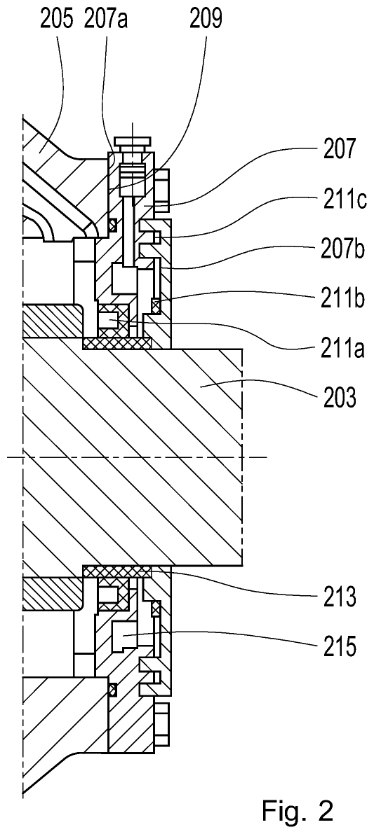

The transmissions according to the FIGS. 1 and 2 each have one input shaft 103, 203. The input shafts 103, 203 penetrate an opening of the respective housing 105, 205. Respectively one cover 109, 209 is provided to close these openings.

The housing 105 of the first transmission and the housing 205 of the first transmission each form a threaded flange 109, 209. The threaded flanges 109, 209 have an identical design. The cover 107 of the first transmission is threaded to the threaded flange 109 of the first transmission. Likewise, the cover 207 of the second transmission is threaded to the threaded flange 209 of the second transmission.

The covers 107, 207 in turn form an opening through which the respective input shaft 103, 203 penetrates. The seals 111, 211a, 211b, 211c are provided to seal this opening against the respective input shaft 103, 203.

The cover 111 of the first transmission has a single radial shaft seal ring 111. The radial shaft seal ring 111 is secured in the cover 107 of the first transmission.

A seal lip of the radial shaft seal ring 111 extends on the surface of a ring 113 that is shrunk onto the input shaft 103 of the first transmission. A corresponding ring 213 is shrunk onto the input shaft 203 of the second transmission. The ring 113 of the first transmission and the ring 213 of the second transmission differ with respect to their component geometry. This enables the use of a different seal arrangement in the second transmission.

The seal arrangement of the second transmission comprises a radial shaft seal ring 211a, a V-ring seal 211b, and a labyrinth seal 211c, The cover 207 is formed as two pieces to accommodate this seal arrangement. A first piece 207a of the cover 207 accommodates the radial shaft seal ring 211a. The first piece 207a is threaded to the threaded flange 209 of the second transmission. Accordingly, the first piece 207a is fitted to the housing.

A second piece 207b of the cover 207 of the first transmission is secured rotationally fixed on the input shaft 203 of the first transmission. When the input shaft 203 rotates, the second piece 207b of the cover 207 of the first transmission appropriately rotates relative to the first piece 207a.

The V-ring seal 211b is secured in the second piece 207b of the cover 207 of the first transmission. Its seal lip extends along the first piece 207a of the cover 207 of the first transmission.

Additionally, the pieces 207a, 207b of the seal ring 207 of the second transmission each form a part of the labyrinth seal 211c. A cavity 215 is located between the V-ring seal 211b and the labyrinth seal 211c. The cavity is filled with grease.

### LIST OF REFERENCE NUMERALS

103 Input shaft
105 Housing
107 Cover
109 Threaded flange
111 Radial shaft seal ring
113 Ring
203 Input shaft
205 Housing
207 Cover
209 Threaded flange
211a Radial shaft seal ring
211b V-Ring seal
211c Labyrinth seal
213 Ring
213a first piece of the ring
213b second piece of the ring
215 Cavity

1-8. (canceled)

9. A transmission type series comprising:
at least two transmissions that each have an input shaft (103, 203), a housing (105, 205), and a cover (107, 207), wherein:
each housing (105, 205) forms a flange (109, 209) in which the respective cover (107, 207) is secured oil-tight;
each input shaft (103, 203) penetrates the respective cover (107, 207);
each cover (107, 207) has at least one seal (111, 211a, 211b, 211c) as a seal against the respective input shaft (103, 105);
each flange (109, 209) has an identical design; and
the at least one seal (111, 211a, 211b, 211c) differs between the at least two transmissions.

10. The transmission type series according to claim 9; wherein the respective cover (107, 207) differs between each of the at least two transmissions.

11. The transmission type series according to claim 9, wherein:
each input shaft (107, 207) has a ring (113, 213);
the ring (113, 213) differs between the input shaft of the at least two transmissions; and
the at least one seal (111, 211a, 211b, 211c) is formed to at least partially form a seal against the respective ring (113, 213).

12. The transmission type series according to claim 10, wherein:
each input shaft (107, 207) has a ring (113, 213);
the ring (113, 213) differs between the input shaft of the at least two transmissions; and
the at least one seal (111, 211a, 211b, 211c) is formed to at least partially form a seal against the respective ring (113, 213).

13. The transmission type series according to claim 12, wherein each input shaft (103, 203) has an identical design in at least one respective part, and wherein the respective ring (113, 213) is arranged on the at least one respective part.

14. The transmission type series according to claim 9, wherein the at least one seal (211a, 211b, 211c) of at least one of the at least two transmissions is formed as a seal arrangement comprising a radial shaft seal ring (211a), a V-ring seal (211b), and a labyrinth seal (211c).

15. The transmission type series according to claim 14, wherein the V-ring seal (211b) together with the labyrinth seal (211c) forms a cavity (215) that is at least partially filled with grease.

16. The transmission type series according to claim 15, wherein at least one seal (111) of at least one further of the at least two transmissions is formed as a radial shaft seal ring.

17. The transmission type series according to claim 9, wherein the housing (105, 205) of each of the at least two transmissions has an identical design.

18. The transmission type series according to claim 13, wherein the housing (105, 205) of each of the at least two transmissions has an identical design.

19. The transmission type series according to claim 15, wherein the housing (105, 205) of each of the at least two transmissions has an identical design.
